(19) United States
(12) Patent Application Publication
(10) Pub. No.: US 2002/0109562 A1
(43) Pub. Date: Aug. 15, 2002

(54) Dielectric filter, dielectric duplexer, and communication device

(75) Inventors: Hideki Tsukamoto, Kanazawa-shi (JP); Katsuhito Kuroda, Matsutou-shi (JP); Jinsei Ishihara, Kanazawa-shi (JP); Hideyuki Kato, Ishikawa-gun (JP); Yukihiro Kitaichi, Ishikawa-gun (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 10/073,452

(22) Filed: Feb. 11, 2002

(30) Foreign Application Priority Data
Feb. 15, 2001 (JP) 2001-038338

(51) Int. Cl. H01P 1/213

(52) U.S. Cl. 333/134; 333/202; 333/206

(57) ABSTRACT

A dielectric filter includes a dielectric block. A plurality of inner-conductor holes, each having an inner conductor on the surface thereof, extend from a first open surface to the opposing surface through the inside of the dielectric block. On the outer surface of the dielectric block, an outer conductor is formed, except on the first open surface. On the first open surface, projections are provided between respective pairs of inner-conductor holes. Coupling electrodes are formed on the side surfaces of the projections and extending onto the first open surface of the dielectric block, where they connect to the inner conductors. On the outer surface of the dielectric block, input/output electrodes are formed such that they couple to the coupling electrodes.

### BACKGROUND OF THE INVENTION

1. Field of the Invention

The present invention relates to a dielectric filter, a dielectric duplexer, and a communication device mainly for use in a microwave band.

2. Description of the Related Art

A known dielectric filter using a substantially rectangular parallelepiped dielectric block is produced by forming TEM-mode resonators, including a dielectric block, inner conductors, and an outer conductor and by coupling the adjacent resonators to each other.

In recent years, miniaturization of dielectric filters to be mounted in communication devices has been required in accordance with the miniaturization of high-frequency communication devices.

However, in order to miniaturize a dielectric filter itself, each element constituting the dielectric filter is required to be miniaturized accordingly. As a result, it may occur that the size of a coupling electrode used for capacitive coupling of resonators is reduced and thus a required coupling capacitance may not be obtained. The required capacitance may be obtained by attaching an external capacitance element, but in that case, problems arise. For example, the number of components may increase and reliability may be degraded due to the use of solder or the like for connecting the components together.

Dielectric filters for overcoming these problems are disclosed in (ref. 1) U.S. Pat. No. 4,742,562, (ref. 2) Japanese Unexamined Patent Application Publication No. 7-86807, and (ref. 3) Japanese Unexamined Patent Application Publication No. 10-65403.

In the dielectric filter disclosed in (ref. 1), through holes whose inner surfaces are covered with a conductive material are formed in a dielectric block whose outer surface is substantially entirely covered with a conductive material except for a first open surface. The through holes extend in the direction from the first open surface of the dielectric block to the opposite surface. Also, curved capacitive structures are provided near open ends of the through holes at the first open surface so as to form coupling electrodes in an interdigital structure. With this configuration, coupling electrodes separated from each other are capacitively coupled by the capacitive structures and the required coupling capacitance can be obtained by changing the lengths of the capacitive structures.

In the dielectric filter disclosed in (ref. 2), a plurality of through holes are provided in a dielectric block having an outer conductor. Also, inner conductors are provided with one end of each of the inner conductors being connected to the outer conductor so as to form a plurality of dielectric resonators. At the ends of the resonators where the inner conductors are not connected to the outer conductor of the dielectric block, concave portions are formed in the dielectric block, containing electrodes connected with the inner conductors. These electrodes allow the required coupling capacitance between the resonators to be obtained.

The dielectric filter disclosed in (ref. 3) has an outer ground electrode on the outer surfaces of a dielectric block except one surface and a plurality of resonators including through holes each having an inner conductor therein. Also, concave portions each having a ground load capacitance electrode, a coupling electrode, and a unit for reducing the amount of floating-capacitance coupling are provided on the surface which does not have the outer ground electrode. The required coupling capacitance is obtained by the coupling electrodes in the concave portions.

However, these known dielectric filters have the following problems, which must be solved.

In the dielectric filter disclosed in (ref. 1), the coupling electrodes are linearly coupled to each other using capacitive structures formed by the conductors on the outer surface of the dielectric block, and thus it is difficult to obtain a sufficient coupling area. Further, if the dielectric filter were further reduced in size, the surface area available for forming each strip would become smaller. As a result, the length of the strip would become shorter and thus the coupling capacitance would be reduced.

In the dielectric filters disclosed in (refs. 2) and (3), the surfaces of the coupling electrodes face each other with a part of the dielectric block therebetween and thus sufficient coupling capacitance may be obtained.

However, the dielectric filter using a dielectric block in which both an inner conductor and an outer conductor are formed by a conductive material and extend from a short-circuited surface to an open surface functions as a resonator including the entire length from the short-circuited surface to the open surface. Therefore, when a concave portion is provided inside the dielectric block and a coupling electrode is formed inside the concave portion, the resonator includes the coupling electrode.

That is, the coupling electrodes facing each other have an influence on both the resonance frequency and the coupling capacitance. Accordingly, the resonance frequency and the coupling capacitance cannot be independently designed. Further, when the coupling electrodes are trimmed for adjusting the coupling capacitance, the resonance frequency is strongly affected and thus, the permissible amount of adjustment is limited.

### SUMMARY OF THE INVENTION

In response to these problems, the present invention provides a compact dielectric filter, dielectric duplexer, and communication device, in which a coupling capacitance and a resonance frequency can easily be independently designed, while obtaining a sufficient coupling capacitance.

According to a first aspect of the present invention, a dielectric filter comprises a substantially rectangular parallelepiped dielectric block; at least two inner-conductor holes, each having an inner conductor on the surface thereof, extending from a first open surface to the opposing surface through the inside of the dielectric block; an outer conductor formed over the outer surfaces except for the first open surface of the dielectric block; a projection provided between the inner-conductor holes and protruding in the axial direction of the inner-conductor holes from the first open surface of the dielectric block; and coupling electrodes, for coupling the inner-conductor holes to each other, provided on the first open surface and on side surfaces of the projection.

With this configuration, a compact dielectric filter having a sufficient coupling capacitance can be achieved. Also, the coupling capacitance and the resonance frequency can be designed independently whereby enhanced design freedom can be achieved. Further, a dielectric filter whose resonance frequency is not influenced even when the coupling electrodes are trimmed for fine adjustment of the coupling capacitance can be achieved.

According to a second aspect of the present invention, a dielectric duplexer which includes the dielectric filter is provided.

With this arrangement, a compact dielectric duplexer having a sufficient coupling capacitance can be achieved. Also, the coupling capacitance and the resonance frequency can be designed independently whereby enhanced design freedom can be achieved. Further, a dielectric duplexer whose resonance frequency is not influenced even when the coupling electrodes are trimmed for fine adjustment of the coupling capacitance can be achieved.

According to a third aspect of the present invention, a communication device which includes the dielectric filter or the dielectric duplexer is provided.

With this arrangement, a compact communication device having excellent communication characteristics can be achieved.

Other features and advantages of the present invention will become apparent from the following description of embodiments of the invention which refers to the accompanying drawings.

### BRIEF DESCRIPTION OF THE DRAWINGS

FIG. 1A is a perspective view of a dielectric filter according to a first embodiment and FIG. 1B is a longitudinal sectional view of the same;

FIG. 2 is an enlarged longitudinal sectional view of a projection;

FIG. 3A is a perspective view of a dielectric filter according to a modification of the first embodiment and FIG. 3B is a longitudinal sectional view of the same;

FIG. 4 is a perspective view of a dielectric filter according to a second embodiment;

FIG. 5 is a perspective view of a dielectric filter according to a third embodiment;

FIG. 6 is a perspective view of a dielectric duplexer according to a fourth embodiment; and

FIG. 7 is a block diagram of a communication device according to a fifth embodiment.

### DESCRIPTION OF EMBODIMENTS OF THE INVENTION

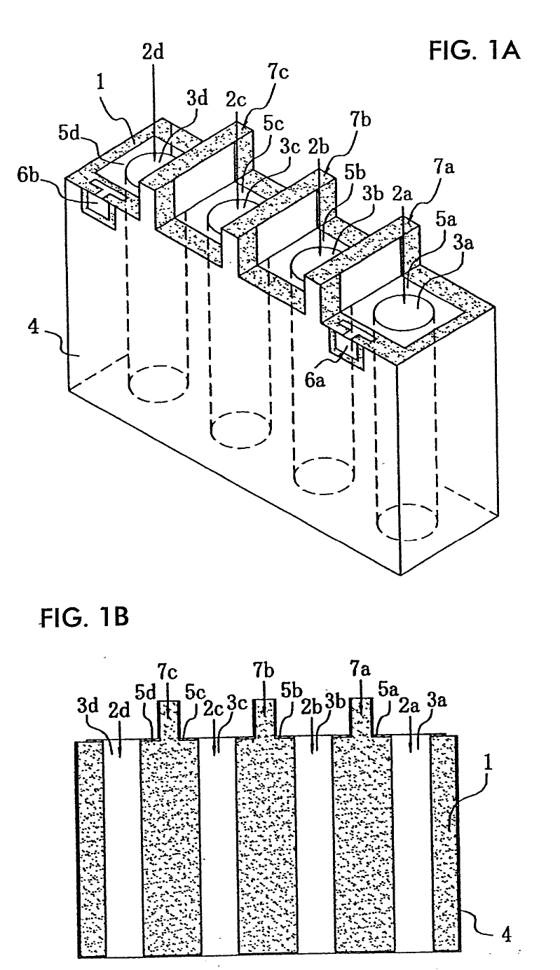

Hereinafter, the configuration of a dielectric filter according to a first embodiment is described with reference to FIGS. 1A to 3B.

FIG. 1A is a perspective view of the dielectric filter and FIG. 1B is a longitudinal sectional view of the same.

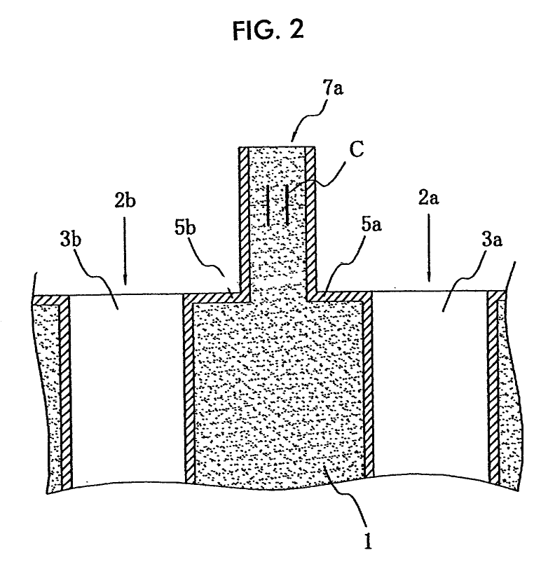

FIG. 2 is an enlarged longitudinal sectional view of a projection of the dielectric filter.

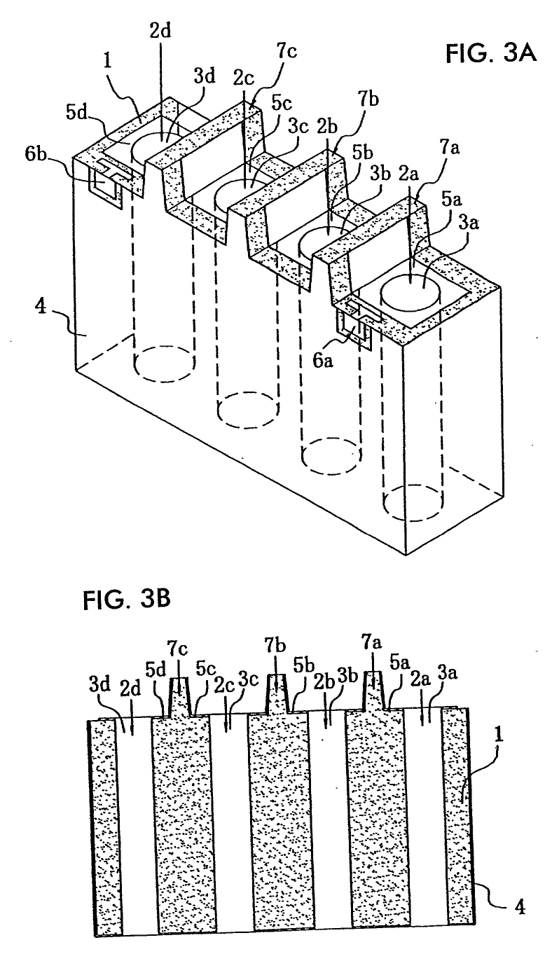

FIG. 3A is a perspective view of a dielectric filter according to a modification of the first embodiment and FIG. 3B is a longitudinal sectional view of the same.

In FIGS. 1A to 3B, the dielectric filter includes a dielectric block 1, innerconductor holes 2a to 2d, inner conductors 3a to 3d, an outer conductor 4, coupling electrodes 5a to 5d, input/output electrodes 6a and 6b, projections 7a to 7c, and a coupling capacitance C.

As shown in FIGS. 1A and 1B, inside the substantially rectangular parallelepiped dielectric block 1, the inner-conductor holes 2a to 2d having the inner conductors 3a to 3d on the surfaces thereof extend in the direction from a first open surface of the dielectric block 1 to the opposite surface. On the outer surface of the dielectric block 1, the outer conductor 4 is formed on five surfaces, that is, on all surfaces except the first open surface of the dielectric block 1.

On the surface of the dielectric block 1 which does not have the outer conductor 4, the projections 7a to 7c are provided between each respective adjacent pair of the inner-conductor holes 2a to 2d. The width of the projections is the same as that of the shorter edge of the first open surface of the dielectric block. The coupling electrodes 5a to 5d are formed on the side surfaces of the projections 7a to 7c which are perpendicular to the alignment direction of the inner-conductor holes, and on the first open surface of the dielectric block 1. These coupling electrodes 5a to 5d are conductively connected with the inner conductors 3a to 3d, respectively, and are isolated from the outer conductor 4.

In this way, a plurality of dielectric resonators are constituted, in which the ends of the inner-conductor holes having the coupling electrodes 5a to 5d is regarded as an open end, and the other end is regarded as a short-circuited end.

Further, the input/output electrodes 6a and 6b are formed on outer surfaces of the dielectric block 1 so that they couple to the coupling electrodes 5a and 5d, respectively, which are formed on the open end, thereby forming the dielectric filter.

In the configuration described above, as shown in FIGS. 1A and 1B, portions of the adjacent coupling electrodes 5a to 5d face each other with the projections 7a to 7c therebetween and thus a greater coupling capacitance C can be obtained.

Also, since the open end and the short-circuited end define the two ends of the inner-conductor holes 2a to 2d, the projections 7a to 7c are not included in the part functioning as a resonator. Consequently, the design of the coupling capacitance, which depends on the shape of the projections 7a to 7c, and the design of the resonator, which does not depend on the shape of the projections 7a to 7c, are independent of each other, whereby the design freedom can be enhanced.

Further, since the projections 7a to 7c are not included in the part functioning as a resonator, characteristics of the resonator, such as the resonance frequency, are not influenced even when the coupling electrodes 5a to 5d formed on the surfaces of the projections 7a to 7c are trimmed for fine adjustment of the coupling capacitance and so on. Accordingly, the dielectric filter having the characteristics of a desired resonator can be achieved while obtaining an appropriate coupling capacitance.

In order to manufacture the dielectric filter, the following method is used.

A substantially rectangular parallelepiped dielectric block having projections is produced by press molding, inner-conductor holes are provided, and inner conductors, an outer conductor, input/output electrodes, and coupling electrodes are formed using a method such as screen printing; partial plating, in which unnecessary portions are covered with resist or the like before plating; or ultrasonic machining, in which conductive material is removed by ultrasonic waves after plating the entire portion.

Further, as shown in FIGS. 3A and 3B, similar advantages can be obtained when the projections 7a to 7c are tapered.

By providing tapered projections, the spaces flanked by adjacent projections expand outward and thus the coupling electrodes can be easily formed on the side surfaces of the projections and on the first open surface of the dielectric block adjacent to the inner-conductor holes.

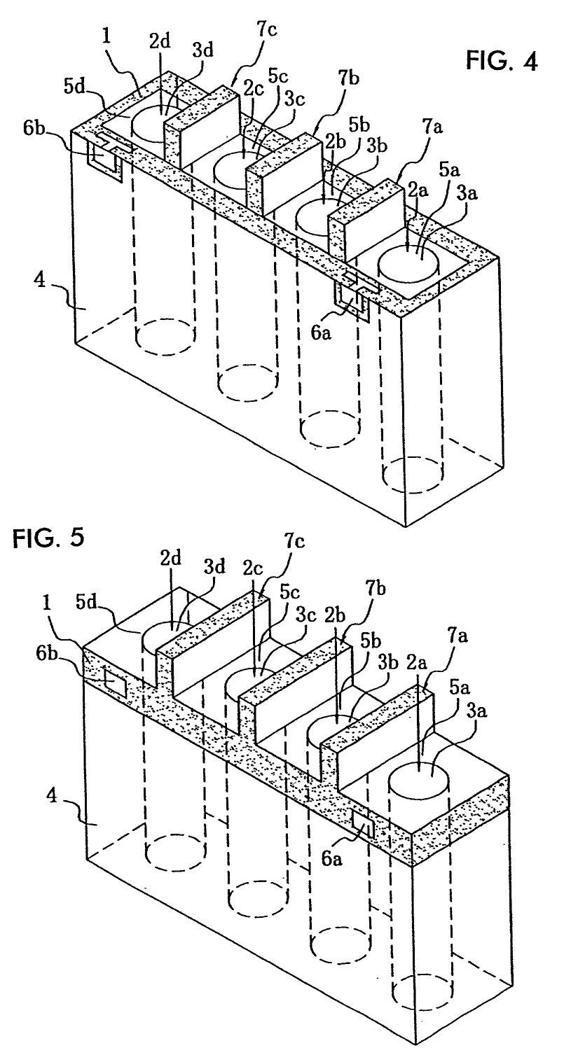

Subsequently, the configuration of a dielectric filter according to a second embodiment is described with reference to FIG. 4.

FIG. 4 is a perspective view of the dielectric filter.

In FIG. 4, the dielectric filter includes a dielectric block 1, inner-conductor holes 2a to 2d, inner conductors 3a to 3d, an outer conductor 4, coupling electrodes 5a to 5d, input/output electrodes 6a and 6b, and projections 7a to 7c.

In the dielectric filter shown in FIG. 4, the projections 7a to 7c are narrower than the shorter edge of a first open surface of the dielectric block 1 and the coupling electrodes 5a to 5d are formed on the entire area of the side surfaces of the projections 7a to 7c. Other than this, the configuration of the dielectric filter is the same as that of the dielectric filter shown in FIGS. 1A and 1B.

With this configuration, the required coupling capacitance can be obtained with smaller projections, and thus a smaller dielectric filter can be achieved.

Next, the configuration of a dielectric filter according to a third embodiment is described with reference to FIG. 5.

FIG. 5 is a perspective view of the dielectric filter.

In FIG. 5, the dielectric filter includes a dielectric block 1, inner-conductor holes 2a to 2d, inner conductors 3a to 3d, an outer conductor 4, coupling electrodes 5a to 5d, input/output electrodes 6a and 6b, and projections 7a to 7c.

Inside the substantially rectangular parallelepiped dielectric block 1, the inner-conductor holes 2a to 2d having the inner conductors 3a to 3d on the surfaces thereof extend in the direction from a first open surface of the dielectric block 1 to the opposite surface. On the outer surface of the dielectric block 1, the outer conductor 4 is formed on five surfaces, that is, all surfaces except the first open surface of the dielectric block 1.

On the four side surfaces communicating with the first open surface, a portion having no outer conductor formed thereon and having a predetermined length in the axial direction of the inner-conductor holes from the first open surface is provided. This portion includes the input/output electrodes 6a and 6b.

On the surface of the dielectric block 1 which does not have the outer conductor 4, the projections 7a to 7c are provided between the inner-conductor holes 2a to 2d. The width of the projections is the same as that of the shorter edge of the first open surface. The coupling electrodes 5a to 5d are formed on the entire area of the side surfaces of the projections 7a to 7c and on the entire area of the first open surface of the dielectric block 1 adjacent to the inner-conductor holes 2a to 2d. These coupling electrodes 5a to 5d are conductively connected with the inner conductors 3a to 3d, respectively. In this way, a plurality of dielectric resonators are constituted, in which the ends of the inner-conductor holes having the coupling electrodes 5a to 5d are regarded as open ends, and the other ends are regarded as short-circuited ends.

Further, these resonators are coupled by the coupling electrodes 5a to 5d and the input/output electrodes 6a and 6b are provided such that they are isolated from the outer conductor 4, thereby forming the dielectric filter.

With this configuration, the width of the coupling electrodes, which face each other, is the same as the full width of the shorter edge of the first open surface of the inner-conductor holes. Accordingly, a greater coupling area and a sufficient coupling capacitance can be easily obtained.

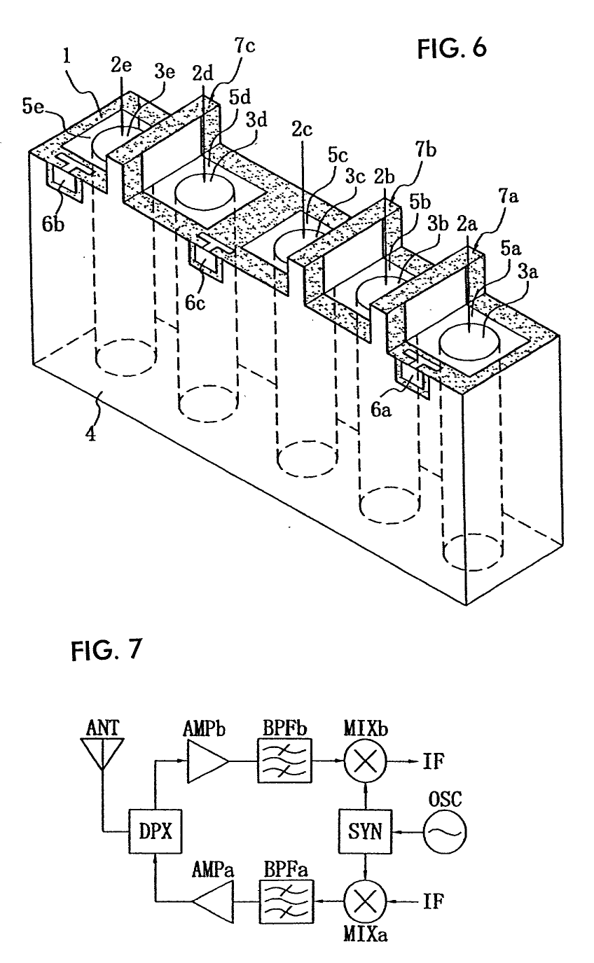

Next, the configuration of a dielectric duplexer according to a fourth embodiment is described with reference to FIG. 6.

FIG. 6 is a perspective view of the dielectric duplexer.

In FIG. 6, dielectric duplexer includes a dielectric block 1, inner-conductor holes 2a to 2e, inner conductors 3a to 3e, an outer conductor 4, coupling electrodes 5a to 5e, input/output electrodes 6a to 6c, and projections 7a to 7c.

Inside the substantially rectangular parallelepiped dielectric block 1, the inner-conductor holes 2a to 2e having the inner conductors 3a to 3e on the surfaces thereof extend in the direction from a first open surface of the dielectric block 1 to the opposite surface. On the outer surface of the dielectric block 1, the outer conductor 4 is formed on five surfaces, that is, all surfaces except the first open surface of the dielectric block 1.

On the surface of the dielectric block 1 which does not have the outer conductor 4, the projections 7a to 7c are provided between the inner-conductor holes 2a to 2e, except between the inner-conductor holes 2c and 2d. The width of the projections is the same as that of the shorter edge of the first open surface of the dielectric block. Also, the coupling electrodes 5a to 5e are formed on the side surfaces of the projections 7a to 7c, which are perpendicular to the alignment direction of the inner-conductor holes, and on the first open surface. These coupling electrodes 5a to 5e are connected with the inner conductors 3a to 3e, respectively, and are isolated from the outer conductor 4.

In this way, a plurality of dielectric resonators are constituted, in which the ends of the inner-conductor holes having the coupling electrodes 5a to 5e are regarded as open ends, and the other ends are regarded as short-circuited ends.

Further, the input/output electrodes 6a to 6c are formed such that they are isolated from the outer conductor 4. The input/output electrode 6a is coupled to the coupling electrode 5a, the electrode 6b is coupled to the electrode 5e, and the electrode 6c is coupled to both of the electrodes 5c and 5d.

Herein, the dielectric block 1, the inner conductors 3a to 3c, the outer conductor 4, and the input/output electrodes 6a and 6c constitute one dielectric filter. Also, the dielectric block 1, the inner conductors 3d and 3e, the outer conductor 4, and the input/output electrodes 6b and 6c constitute the other dielectric filter. These filters constitute a dielectric duplexer in which one dielectric filter is regarded as a transmission filter and the other dielectric filter is regarded as a reception filter.

With this configuration, a compact dielectric duplexer in which each of the resonators has a sufficient coupling capacitance can be achieved.

Also, the coupling capacitance and the resonance frequency can be designed independently, whereby a dielectric duplexer with enhanced design freedom can be achieved.

Further, a dielectric duplexer whose resonance frequency is not influenced even when the coupling electrodes are trimmed for fine adjustment of the coupling capacitance can be achieved.

Incidentally, in the dielectric filters according to the first to third embodiments and the dielectric duplexer according to the fourth embodiment, the inner-conductor holes may have a step structure, that is, the inner diameter of each of the inner-conductor holes at the open end may be larger than that at the short-circuited end.

Further, the cross section of the inner-conductor hole is not limited to a circle, but it may be oval-shaped, oblong-shaped, or polygonal-shaped.

Next, a communication device according to a fifth embodiment is described with reference to FIG. 7.

FIG. 7 is a block diagram of the communication device.

In FIG. 7, the communication device includes a transmission/reception antenna ANT, a duplexer DPX, bandpass filters BPFa and BPFb, amplifier circuits AMPa and AMPb, mixers MIXa and MIXb, an oscillator OSC, and a synthesizer SYN. IF represents an intermediate-frequency signal.

The dielectric filters shown in FIGS. 1A, 1B, 3A, 3B, 4, and 5 can be used for the bandpass filters BPFa and BPFb shown in FIG. 7. Also, the dielectric duplexer shown in FIG. 6 can be used for the duplexer DPX. In this way, a compact communication device having excellent communication characteristics can be achieved by using the compact dielectric filter and the dielectric duplexer having a sufficient coupling capacitance.

Although the present invention has been described in relation to particular embodiments thereof, many other variations and modifications and other uses will become apparent to those skilled in the art. Therefore, the present invention is not limited by the specific disclosure herein.

What is claimed is:

1. A dielectric filter comprising:
a substantially rectangular parallelepiped dielectric block;
two inner-conductor holes, each having an inner conductor on the surface thereof, extending from a first open surface to the opposing surface through the inside of the dielectric block;
an outer conductor formed over the outer surfaces other than the first open surface of the dielectric block, a plurality of resonators thereby being defined;
a projection provided between the inner-conductor holes and protruding from the first open surface in the axial direction of the inner-conductor holes; and
coupling electrodes, which couple the inner-conductor holes to each other, provided on the first open surface and on the side surfaces of the projection.

2. A dielectric filter as in claim 1, wherein said projection has the same width as a shorter edge of the first open surface of the dielectric block.

3. A dielectric filter as in claim 2, wherein said coupling electrodes are narrower than said projection.

4. A dielectric filter as in claim 2, wherein said coupling electrodes have the same width as a shorter edge of the first open surface of the dielectric block.

5. A dielectric filter as in claim 1, wherein said coupling electrodes are narrower than a shorter edge of the first open surface of the dielectric block.

6. A dielectric filter as in claim 1, wherein said coupling electrodes have the same width as a shorter edge of the first open surface of the dielectric block.

7. A dielectric filter as in claim 1, wherein said projection is narrower than a shorter edge of the first open surface of the dielectric block.

8. A dielectric filter as in claim 7, wherein said coupling electrodes have the same width as said projection.

9. A dielectric filter as in claim 1, wherein said projection is tapered to become thinner as it extends away from said first open surface.

10. A dielectric duplexer comprising a pair of dielectric filters, at least one of said filters being a dielectric filter according to claim 1.

11. A communication device comprising a transmitting circuit, a receiving circuit, and a dielectric duplexer according to claim 10, said transmitting circuit being connected to an input of one of said dielectric filters, said receiving circuit being connected to an output of the other of said dielectric filters.

12. A communication device comprising at least one of a transmitting circuit and a receiving circuit, said circuit including a dielectric filter according to claim 1.
